(19) United States
(12) Patent Application Publication
(10) Pub. No.: US 2009/0126761 A1
(43) Pub. Date: May 21, 2009

(54) Cleaning apparatus and cleaning method

(75) Inventor: Takehiko Orhii, Tosu-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: Tokyo Electron Limited

(21) Appl. No.: 12/292,400

(22) Filed: Nov. 18, 2008

(30) Foreign Application Priority Data
Nov. 21, 2007 (JP) 2007-301874
Nov. 21, 2007 (JP) 2007-301886

(51) Int. Cl. B08B 7/04

(52) U.S. Cl. 134/6; 134/148

(57) ABSTRACT

A cleaning apparatus cleans a peripheral part of a substrate to be processed W. The cleaning apparatus includes a first cleaning part 11 configured to be brought into contact with a peripheral part of a front surface Wa of the substrate to be processed W and rotated in an in-plane direction of the substrate to be processed W, and a second cleaning part configured to be brought into contact with a peripheral part of a rear surface Wb of the substrate to be processed W and rotated in the in-plane direction of the substrate to be processed W. A frictional force to be applied from the second cleaning part 12 to the rear surface Wb of the substrate to be processed W is larger than a frictional force to be applied from the first cleaning part 11 to the front surface Wa of the substrate to be processed.

### CROSS REFERENCE TO RELATED APPLICATIONS

This application is based upon and claims the benefit of priority from the prior Japanese Patent Application Nos. 2007-301886 and 2007-301874 filed on Nov. 21, 2007, the entire contents of which are incorporated herein by reference.

### FIELD OF THE INVENTION

The present invention relates to a cleaning apparatus and a cleaning method for cleaning a peripheral part of a substrate to be processed.

### BACKGROUND ART

There is conventionally known a method of etching a peripheral part of a substrate to be processed with the use of an etching liquid (cleaning liquid). As such a method of cleaning a wafer, there is known an apparatus, for example, which includes a holding and driving mechanism that circumferentially drives a wafer in rotation while holding the wafer, and an etching tank containing an etching liquid into which the peripheral part of the wafer being driven in rotation is immersed and etched (see, JP2004-296810A).

In addition, in order to improve a throughput in a cleaning method for cleaning a peripheral part of a wafer as a substrate to be processed, there is known a method in which a plurality of wafers are cleaned by a batch process.

As a method for cleaning wafers by a batch process, there is known a method, for example, in which a plurality of wafers are subjected to a batch process such that the wafers are stacked, and the peripheral parts of the wafers are brought into contact with an etching liquid (cleaning liquid) so as to be etched (see, JP5-243208A). Another known method for subjecting a plurality of wafers to a batch process is as follows (see, JP2003-203899A). Some of the wafers are placed between thin plates of substantially the same shape as that of the wafer to form a stacked body. Substantially all the areas of the exposed surfaces of the wafers are brought into contact with an etching liquid (cleaning liquid) which is being renewed. The stacked body having the wafers between the thin plates is rotated about a central axis of the stacked body, and a rod-like brush having bristles is rotated about the central axis.

Generally, particles are likely to adhere to a front surface of a wafer, and impurities such as polymers are likely to adhere to a rear surface of the wafer (hereinafter, such impurities are referred to as polymers). As compared with the particles adhering to the front surface of the wafer, the polymers adhering to the rear surface of the wafer are difficult to be removed from the wafer. Thus, it is difficult to reliably remove the polymers adhering to the rear surface of the wafer by using a conventional cleaning apparatus. When a cleaning liquid containing a potent chemical liquid so as to remove the polymers adhering to the rear surface of the wafer, the front surface of the wafer may be undesirably eroded.

### DISCLOSURE OF THE INVENTION

The present invention has been made in view of the above circumstances. The object of the present invention is to provide a cleaning apparatus in which, when a substrate to be processed is cleaned, even in a case in which different objects are intended to be removed from the one surface and the other surface of the substrate to be processed, the respective objects can be reliably removed. In addition, polymers and causes of particles, such as dusts, adhering to the substrate to be processed can be reliably removed, without erosion of the substrate to be processed.

A cleaning apparatus in a first embodiment of the present invention is a cleaning apparatus for cleaning a peripheral part of a substrate to be processed, comprising: a first cleaning part configured to be brought into contact with a peripheral part of one surface of the substrate to be processed, and configured to be driven in rotation in an in-plane direction of the substrate to be processed; and a second cleaning part configured to be brought into contact with a peripheral part of the other surface of the substrate to be processed, and configured to be driven in rotation in the in-plane direction of the substrate to be processed; wherein a frictional force to be applied from the second cleaning part to the other surface of the substrate to be processed is larger than a frictional force to be applied from the first cleaning part to the one surface of the substrate to be processed.

Due to this structure, when a substrate to be processed is cleaned, even in a case in which different objects are intended to be removed from the one surface and the other surface of the substrate to be processed, the respective objects can be reliably removed. In addition, polymers and causes of particles, such as dusts, adhering to the substrate to be processed can be reliably removed, without erosion of the substrate to be processed.

In the cleaning apparatus in the first embodiment of the present invention, it is preferable that the second cleaning part is rotated at a higher speed than the first cleaning part.

In the cleaning apparatus in the first embodiment of the present invention, it is preferable that an area of the second cleaning part to be in contact with the other surface of the substrate to be processed is larger than an area of the first cleaning part to be in contact with the one surface of the substrate to be processed.

In the cleaning apparatus in the first embodiment of the present invention, it is preferable that the first cleaning part and the second cleaning part are made of different materials, and a coefficient of friction of the material for making the second cleaning part against the substrate to be processed is larger than a coefficient of friction of the material for making the first cleaning part against the substrate to be processed.

In the cleaning apparatus in the first embodiment of the present invention, it is preferable that when viewed from a predetermined direction, the second cleaning part is rotated oppositely to the first cleaning part.

Due to this structure, a frictional force to be applied from the second cleaning part to the other surface can be further increased, whereby polymers adhering to the rear surface of the substrate to be processed can be reliably removed.

In the cleaning apparatus in the first embodiment of the present invention, it is preferable that the cleaning apparatus further comprises a containing tank configured to contain a cleaning liquid; a supply part connected to the containing tank, the supply part being configured to supply a cleaning liquid into the containing tank; a discharge part connected to the containing tank, the discharge part being configured to discharge a cleaning liquid contained in the containing tank; and a suction part connected to an upper part of the containing tank, the suction part being configured to suck and discharge the cleaning liquid from the upper part of the containing tank; wherein the first cleaning part and the second cleaning part support the substrate to be processed such that an in-plane direction of the substrate to be processed is oriented to substantially the vertical direction.

Due to this structure, the cleaning liquid, which has cleaned the peripheral part of the substrate to be processed and remains thereon can be prevented from being moved upward in accordance with the rotation of the substrate to be processed. Thus, an adverse effect upon the substrate to be processed can be prevented, which might be caused by the cleaning liquid moving downward along the substrate to be processed.

A cleaning method in a first embodiment of the present invention is a cleaning method for cleaning a peripheral part of a substrate to be processed, the cleaning method being performed by a cleaning apparatus including a first cleaning part configured to be driven in rotation in an in-plane direction of the substrate to be processed, and a second cleaning part configured to be driven in rotation in the in-plane direction of the substrate to be processed, the cleaning method comprising: a step in which a substrate to be processed is interposed between the first cleaning part and the second cleaning part such that the first cleaning part is brought into contact with a peripheral part of one surface of the substrate to be processed and that the second cleaning part is brought into contact with a peripheral part of the other surface of the substrate to be processed; and a step in which a frictional force is applied by the second cleaning part to the other surface of the substrate to be processed, the frictional force being larger than a frictional force to be applied by the first cleaning part to the one surface of the substrate to be processed.

Due to this method, when a substrate to be processed, even in a case in which different objects are intended to be removed from the one surface and the other surface of the substrate to be processed, the respective objects can be reliably removed. In addition, polymers and causes of particles, such as dusts, adhering to the substrate to be processed can be reliably removed, without erosion of the substrate to be processed.

A cleaning apparatus in a second embodiment of the present invention is a cleaning apparatus for cleaning peripheral parts of a plurality of substrates to be processed that are held substantially in the vertical direction, the cleaning apparatus comprising: a containing tank configured to contain a cleaning liquid; a first cleaning part disposed in the cleaning tank, the first cleaning part being configured to be brought into contact with a peripheral part of one surface of the substrate to be processed, and configured to be driven in rotation in an in-plane direction of the substrate to be processed; and a second cleaning part disposed in the cleaning tank, the second cleaning part being configured to be brought into contact with a peripheral part of the other surface of the substrate to be processed, and configured to be driven in rotation in the in-plane direction of the substrate to be processed; wherein at least one of the first cleaning part and the second cleaning part comprises a plurality of cleaning parts, and a frictional force to be applied from the second cleaning part to the other surface of the substrate to be processed is larger than a frictional force to be applied from the first cleaning part to the one surface of the substrate to be processed.

Due to this structure, even when different objects are intended to be removed from the one surface and the other surface of the substrate to be processed, the respective objects can be reliably removed. In addition, even when a plurality of substrates to be processed are cleaned by a batch process, polymers and causes of particles, such as dusts, adhering to each of the substrates to be processed can be reliably removed, without erosion of the substrates to be processed.

In the cleaning apparatus in the second embodiment of the present invention, it is preferable that the first cleaning part and the second cleaning part are alternately arranged.

In the cleaning apparatus in the second embodiment of the present invention, it is preferable that the second cleaning part is rotated at a higher speed than the first cleaning part.

In the cleaning apparatus in the second embodiment of the present invention, it is preferable that an area of the second cleaning part to be in contact with the other surface of the substrate to be processed is larger than an area of the first cleaning part to be in contact with the one surface of the substrate to be processed.

In the cleaning apparatus in the second embodiment of the present invention, it is preferable that the first cleaning part and the second cleaning part are made of different materials, and a coefficient of friction of the material for making the second cleaning part against the substrate to be processed is larger than a coefficient of friction of the material for making the first cleaning part against the substrate to be processed.

In the cleaning apparatus in the second embodiment of the present invention, it is preferable that when viewed from a predetermined direction, the second cleaning part is rotated oppositely to the first cleaning part.

Due to this structure, a frictional force to be applied from the second cleaning part to the other surface can be further increased, whereby polymers adhering to the rear surface of the substrate to be processed can be reliably removed.

In the cleaning apparatus in the second embodiment of the present invention, it is preferable that the cleaning apparatus further comprises a supply part connected to the containing tank, the supply part being configured to supply a cleaning liquid into the containing tank; a discharge part connected to the containing tank, the discharge part being configured to discharge a cleaning liquid contained in the containing tank; and a suction part connected to an upper part of the containing tank, the suction part being configured to suck and discharge the cleaning liquid from the upper part of the containing tank.

Due to this structure, the cleaning liquid, which has cleaned the peripheral part of the substrate to be processed and remains thereon can be prevented from being moved upward in accordance with the rotation of the substrate to be processed. Thus, an adverse effect upon the substrate to be processed can be prevented, which might be caused by the cleaning liquid moving downward along the substrate to be processed.

A cleaning method in a second embodiment of the present invention is a cleaning method for cleaning peripheral parts of a plurality of substrates to be processed that are held substantially in the vertical direction, the cleaning method being performed by a cleaning apparatus including: a containing tank configured to contain a cleaning liquid; a first cleaning part disposed in the containing tank, the first cleaning part being configured to be driven in rotation in an in-plane direction of the substrate to be processed; and a second cleaning part disposed in the containing tank, the second cleaning part being configured to be driven in rotation in the in-plane direction of the substrate to be processed; wherein at least one of the first cleaning part and the second cleaning part comprises a plurality of cleaning parts; the cleaning method comprising: a step in which a substrate to be processed is interposed between the first cleaning part and the second cleaning part substantially in the vertical direction such that the first cleaning part is brought into contact with a peripheral part of one surface of the substrate to be processed and that the second cleaning part is brought into contact with a peripheral part of the other surface of the substrate to be processed; and a step in which a frictional force is applied by the second cleaning part to the other surface of the substrate to be processed, the frictional force being larger than a frictional force to be applied by the first cleaning part to the one surface of the substrate to be processed.

Due to this method, even when different objects are intended to be removed from the one surface and the other surface of the substrate to be processed, the respective objects can be reliably removed. In addition, even when a plurality of substrates to be processed are cleaned by a batch process, polymers and causes of particles, such as dusts, adhering to each of the substrates to be processed can be reliably removed, without erosion of the substrates to be processed.

According to the present invention, a frictional force to be applied to the other surface of a substrate to be processed, to which polymers are likely to adhere, can be made larger than a frictional force to be applied to one surface to which particles are likely to adhere. Thus, when a substrate to be processed is cleaned, even in a case in which different objects are intended to be removed from the one surface and the other surface of the substrate to be processed, the respective objects can be reliably removed. In addition, polymers and causes of particles, such as dusts, adhering to the substrate to be processed can be reliably removed, without erosion of the substrate to be processed.

### BRIEF DESCRIPTION OF THE DRAWINGS

FIG. 1 is a side sectional view of a cleaning apparatus in a first embodiment of the present invention.

FIG. 2(a) is an upper plan view of the cleaning apparatus in the first embodiment of the present invention when viewed from a direction shown by the arrow II in FIG. 1, and FIG. 2(b) is a longitudinal sectional view showing a holding member.

FIG. 3 is an upper plan view showing another example of the cleaning apparatus in the first embodiment of the present invention.

FIG. 4 is an upper plan view showing a cleaning apparatus in a second embodiment of the present invention.

FIG. 5 is an upper plan view showing a cleaning apparatus in a third embodiment of the present invention.

FIG. 6 is an upper plan view showing a cleaning apparatus in another modification of the present invention.

FIG. 7 is a front view of a cleaning apparatus in still another modification of the present invention.

FIG. 8 is a side sectional view of a cleaning apparatus in a fourth embodiment of the present invention.

FIG. 9(a) is a front view of the cleaning apparatus in the fourth embodiment of the present invention when viewed from a direction shown by the arrow IX in FIG. 8, and FIG. 9(b) is a longitudinal sectional view showing a holding member.

FIG. 10 is a front view showing another example of the cleaning apparatus in the fourth embodiment of the present invention.

FIG. 11 is a front view showing a cleaning apparatus in a fifth embodiment of the present invention.

FIG. 12 is a front view showing a cleaning apparatus in a sixth embodiment of the present invention.

### EMBODIMENTS FOR CARRYING OUT THE INVENTION

### First Embodiment

A first embodiment of the cleaning apparatus and the cleaning method of the present invention will be described herebelow with reference to the drawings. FIGS. 1 to 3 show the first embodiment of the present invention.

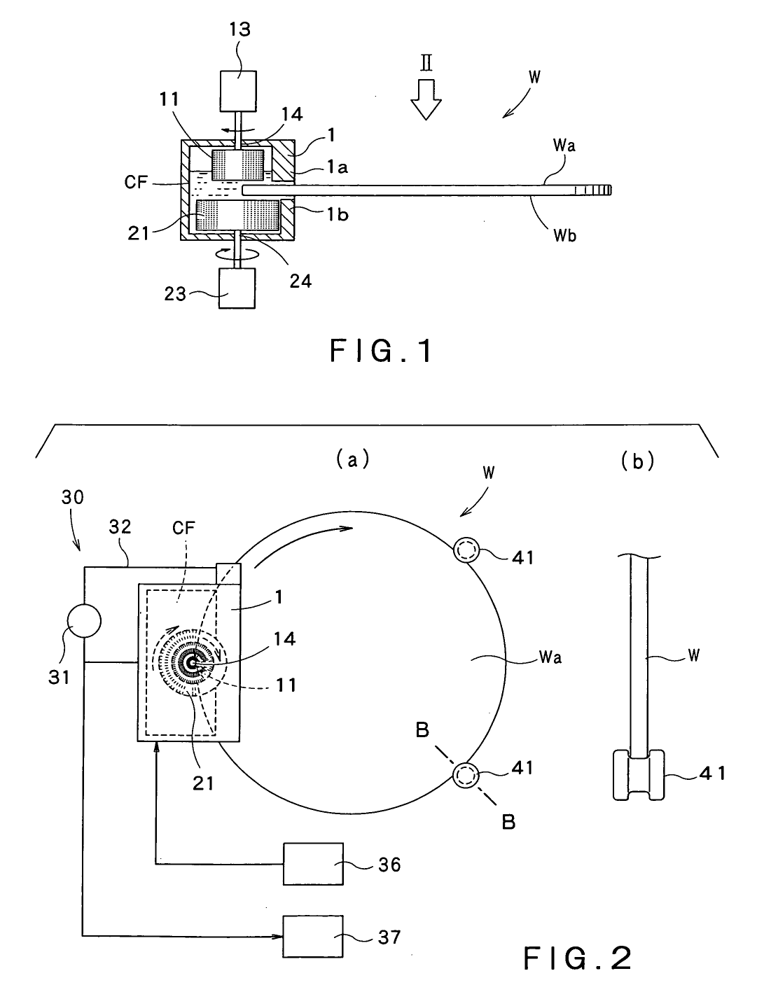

As shown in FIGS. 1 and 2(a), a cleaning apparatus in this embodiment is adapted to clean a peripheral part of a semiconductor wafer W (hereinafter also referred to simply as wafer W) as a substrate to be processed. FIG. 1 is a side sectional view of the cleaning apparatus in this embodiment. FIG. 2 is an upper plan view of the cleaning apparatus in this embodiment when viewed from a direction shown by the arrow II in FIG. 1. FIG. 2(b) is a longitudinal view of a holding member 41 (described below) taken along the line B-B line in FIG. 2(a).

As shown in FIG. 1, the cleaning apparatus includes: a containing tank 1 configured to contain a cleaning liquid CF; a first cleaning brush (first cleaning part) 11 disposed in an upper part of the containing tank 11, the first cleaning brush 11 being configured to be brought into contact a peripheral part of a front surface (one surface) Wa of a wafer W and configured to be rotated in an in-plane direction of the wafer W; and a second cleaning brush (second cleaning part) 21 disposed in a lower part of the containing tank 11, the second cleaning brush 21 being configured to be brought into contact with a peripheral part of a rear surface (the other surface) Wb of the wafer W and configured to be rotated in the in-plane direction of the wafer W.

The cleaning liquid CF is made of a deionized water or a mixed liquid in which a deionized water and a chemical liquid are mixed. The chemical liquid is made of an acid solution such as HF, an alkaline solution such as NH₃, or an organic solvent.

As shown in FIGS. 1 and 2(a), a size of the second cleaning brush 21 is larger than a size of the first cleaning brush 11, and thus an area of the second cleaning brush 21 to be in contact with the rear surface Wb of the wafer W is larger than an area of the first cleaning brush 11 to be in contact with the front surface Wa of the wafer W.

As shown in FIG. 1, the first cleaning brush 11 is connected to a first drive motor 13 via a first rotational shaft 14. On the other hand, the second cleaning brush 21 is connected to a second drive motor 23 via a second rotational shaft 24.

As shown in FIG. 2(a), when viewed from a direction shown by the arrow II in FIG. 1 (from a predetermined direction), the second cleaning brush 21 is rotated in the same direction as the cleaning brush 11. Specifically, when viewed from the direction shown by the arrow II in FIG. 1, the second cleaning brush 21 is rotated counterclockwise by the second drive motor 23, and the first cleaning brush 11 is rotated counterclockwise as well by the first drive motor 13 (see, the arrow in FIG. 2(a)).

In FIG. 2(a), a rotational speed of the second drive motor 23 is higher than a rotational speed of the first drive motor 13, so that the second cleaning brush 21 is rotated at a higher speed than the first cleaning brush 11.

As shown in FIG. 2(a), two holding members 41 for supporting the rear surface Wb of the wafer W are located at a height position which is substantially the same as a height position of an upper surface of the second cleaning brush 21. The rear surface Wb of the wafer W is supported by the holding members 41 and the second cleaning brush 21 such that the in-plane direction of the wafer W is oriented to substantially the horizontal direction. As shown in FIG. 2(b), the holding member 41 has a recessed portion, whereby the wafer W can be positioned and held in the recessed portion.

As shown in FIG. 2(a), connected to the containing tank 1 are a supply part 36 that supplies the cleaning liquid CF into the containing tank 1, and a discharge part 37 that discharges the cleaning liquid CF contained in the containing tank 1. As shown in FIG. 2(a), preferably connected to the containing tank 1 is a suction part 30 that sucks and discharges the cleaning liquid from the containing tank 1. As shown in FIG. 2(a), the suction part 30 includes a suction pipe 32 that is connected to an upper part of the containing tank 1 and is extended to the discharge part 37, and a suction pump 31 disposed in the suction pipe 32 for sucking and discharging the cleaning liquid from the containing tank 1. The suction pipe 32 is connected to the containing tank 1 such that the suction pipe 32 is divided into two branches which are extended to the side of the front surface Wa and the side of the rear surface Wb of the wafer W. Thus, the cleaning liquid CF can be sucked and discharged from both the sides of the front surface Wa and the rear surface Wb of the wafer W.

As shown in FIG. 1, a longitudinal section of the containing tank 1 has a substantially rectangular shape with an opening through which the wafer W is inserted. The containing tank 1 has an upper projecting part 1a extending downward from an upper end, and a lower projecting part 1b extending upward from a lower end.

Next, an operation of this embodiment as structured above is described.

At first, a wafer W is placed on the second cleaning brush 21 and the holding members 41. At this time, the wafer W is interposed between the second cleaning brush 21 and the first cleaning brush 11 such that the front surface Wa of the wafer W to which particles are likely to adhere is brought into contact with the first cleaning brush 11 and that the rear surface Wb of the wafer W to which polymers are likely to adhere is brought into contact with the second cleaning brush 21.

Then, the first cleaning brush 11 is driven in rotation by the first drive motor 13, and the second cleaning brush 21 is driven in rotation by the second drive motor 23 (see, FIGS. 1 and 2(a). Specifically, when viewed from the direction shown by the arrow II in FIG. 1, the second cleaning brush 21 is rotated counterclockwise, and the first cleaning brush 11 is rotated counterclockwise as well (see, the arrow in FIG. 2(a)).

Since the first cleaning brush 11 and the second cleaning brush 21 are driven in rotation, the wafer W is rotated in the in-plane direction by frictional forces applied by the first cleaning brush 11 and the second cleaning brush 21. At this time, when viewed from the direction shown by the arrow II in FIG. 1, the wafer W is rotated clockwise (see, FIG. 2(a)).

As shown in FIGS. 1 and 2(a), the size of the second cleaning brush 21 is larger than the size of the first cleaning brush 11, and thus the area of the second cleaning brush 21 to be in contact with the rear surface Wb of the wafer W is larger than the area of the first cleaning brush 11 to be in contact with the front surface Wa of the wafer W.

Thus, a larger frictional force can be applied to the rear surface Wb to which polymers difficult to be removed from the wafer W are likely to adhere, while a frictional force smaller than the frictional force to be applied to the rear surface Wb can be applied to the front surface Wa to which particles easy to be removed from the wafer W are likely to adhere.

In addition, the rotational speed of the second drive motor 23 is higher than the rotational speed of the first drive motor 13, so that the second cleaning brush 21 is rotated at a higher speed than the first cleaning brush 11. This fact also makes it possible that a larger frictional force can be applied to the rear surface Wb to which polymers difficult to be removed from the wafer W are likely to adhere, and that a frictional force smaller than the frictional force to be applied to the rear surface Wb can be applied to the front surface Wa to which particles easy to be removed from the wafer W are likely to adhere.

According to this embodiment, the frictional force to be applied from the second cleaning brush 21 to the rear surface Wb of the wafer W can be made larger than the frictional force to be applied from the first cleaning brush 11 to the front surface Wa of the substrate to be processed. Thus, even when different objects are intended to be removed from the front surface Wa and the rear surface Wb of the wafer W, the respective objects can be reliably removed. More specifically, causes of particles, such as dusts, adhering to the front surface Wa of the wafer W and polymers adhering to the rear surface Wb of the wafer W can be reliably removed. In addition, the polymers adhering to the rear surface Wb of the wafer W can be reliably removed, without needlessly increasing the concentration of a chemical liquid contained in the cleaning liquid CF (the polymers may be removed by a deionized water in some cases). Thus, the front surface Wa of the wafer W can be prevented from being eroded by the chemical liquid contained in the cleaning liquid CF.

Further, since the frictional force smaller than the frictional force to be applied to the rear surface Wb can be applied to the front surface Wa of the wafer W, the front surface Wa of the wafer W can be prevented from being damaged by the first cleaning brush 11.

Namely, according to the conventional technique, when a wafer is cleaned by a cleaning liquid containing a chemical liquid of a lower concentration, polymers adhering to a rear surface of the wafer cannot be sufficiently removed. Meanwhile, when a cleaning liquid containing a potent chemical liquid is used so as to remove polymers adhering to the rear surface, a front surface of the wafer W may be undesirably eroded.

On the other hand, according to this embodiment, since the frictional force to be applied from the second cleaning brush 21 to the rear surface Wb of the wafer W is made larger, even when a cleaning liquid containing a chemical liquid of a lower concentration (a deionized water may be used in some cases), polymers adhering to the rear surface Wb of the wafer W can be reliably removed. Since such a cleaning liquid containing a chemical liquid of a lower concentration can be used, the front surface Wa of the wafer W can be prevented from being eroded.

Further, in this embodiment, since the frictional force to be applied to the front surface Wa of the wafer W is made smaller, the front surface Wa of the wafer W can be prevented from being damaged by the first cleaning brush 11.

As shown in FIG. 2(a), since the cleaning liquid is sucked and discharged from the containing tank 1, the cleaning liquid CF, which has cleaned the peripheral part of the wafer W and remains thereon, can be prevented from being moved in accordance with the rotation of the wafer W. Thus, spreading of the cleaning liquid CF to a part of the front surface Wa and a part of the rear surface Wb of the wafer W (the parts should not to be cleaned by the cleaning liquid CF) can be prevented, whereby an adverse effect upon the wafer W can be prevented.

As shown in FIG. 1, the containing tank 1 has the upper projecting part 1a extending downward from the upper end and the lower projecting part 1b extending upward from the lower end, and a gap between the upper projecting part 1a and the lower projecting part 1b is very narrow. Thus, the spreading of the cleaning liquid CF to the front surface Wa and the rear surface Wb of the wafer W can be more reliably prevented, whereby an adverse effect upon the wafer W can be reliably prevented.

As described above, since the wafer W is supported such that the in-plane direction is oriented to the horizontal direction and is rotated in the in-plane direction, the cleaning liquid which has adhered to the peripheral part of the wafer W is diffused outward of the peripheral part by a centrifugal force generated by the rotation of the wafer W. Thus, according to this embodiment, the cleaning liquid which has cleaned the peripheral part of the wafer W can be reliably prevented from spreading over the front surface Wa and the rear surface Wb of the wafer W. Accordingly, an adverse effect upon the wafer W can be more reliably prevented.

In the above description, there has been explained the case in which the area of the second cleaning brush 21 to be contact with the rear surface Wb of the wafer W is larger than the area of the first cleaning brush 11 to be in contact with the front surface Wa of the wafer W, and the second cleaning brush 21 is rotated at a higher speed than the first cleaning brush 11. However, when an adhesiveness of the polymers to the rear surface Wb of the wafer W is not so strong, adoption of only one of the above conditions may be sufficient.

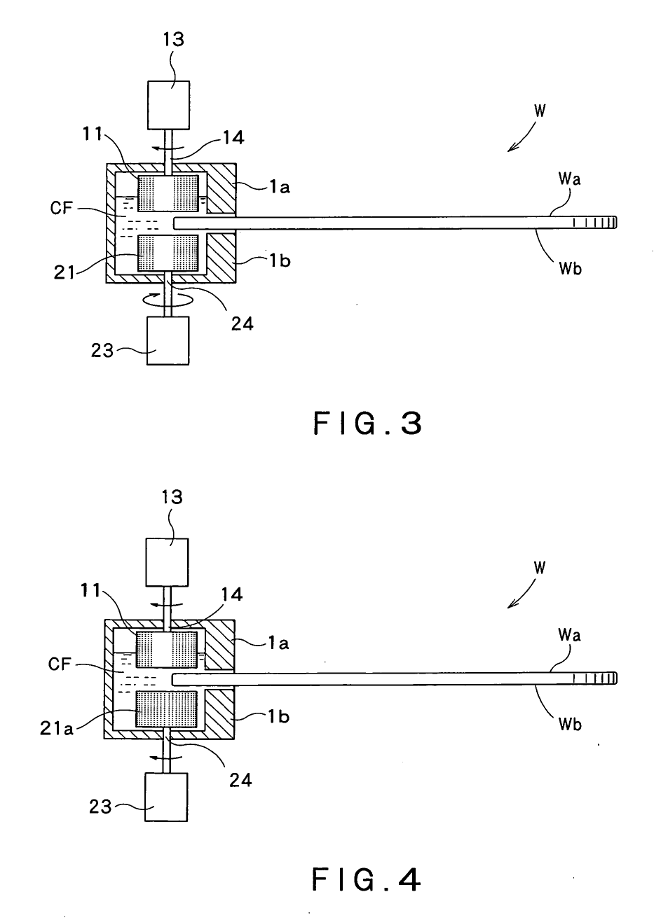

That is, in FIG. 2(a), the second cleaning brush 21 may be rotated at the same speed as the first cleaning brush 11. Alternatively, as shown in FIG. 3, the size of the second cleaning brush 21 may be the same as the size of the first cleaning brush 11 so as to make substantially equal the area of the second cleaning brush 21 to be in contact with the rear surface Wb of the wafer W and the area of the first cleaning brush 11 to be in contact with the front surface Wa of the wafer W to each other, and the second cleaning brush 21 may be rotated at a higher speed than the first cleaning brush 11.

### Second Embodiment

Next, a second embodiment of the present invention will be described with reference to FIG. 4. In the second embodiment shown in FIG. 4, a first cleaning brush 11 and a second cleaning brush 21a are made of different materials, and a coefficient of friction of the material for making the second cleaning brush 21a against a wafer W is larger than a coefficient of friction of the material for making the first cleaning brush 11 against the wafer W. Further, a size of the second cleaning brush 21a is about the same as a size of the first cleaning brush 11, and thus an area of the second cleaning brush 21a to be in contact with a rear surface Wb of the wafer W is substantially equal to an area of the first cleaning brush 11 to be in contact with a front surface Wa of the wafer W. Furthermore, the second cleaning brush 21a is rotated at the same speed as the first cleaning brush 11. Other structures are substantially the same as those of the first embodiment shown in FIGS. 1 and FIGS. 2(a) and 2(b).

In the second embodiment shown in FIG. 4, the components identical to those shown in FIG. 1 and FIGS. 2(a) and 2(b) are represented by the same reference numbers, and a detailed description thereof is omitted.

In FIG. 4, the first cleaning brush 11 and the second cleaning brush 21a are made of different materials, and the coefficient of friction of the material for making the second cleaning brush 21a against the wafer W is larger than the coefficient of friction of the material for making the first cleaning brush 11 against the wafer W.

Thus, similarly to the first embodiment, a larger frictional force can be applied to the rear surface Wb to which polymers difficult to be removed from the wafer W are likely to adhere, while a frictional force smaller than the frictional force to be applied to the rear surface Wb can be applied to the front surface Wa to which particles easy to be removed from the wafer W are likely to adhere.

As a result, the polymers adhering to the rear surface Wb of the wafer W can be reliably removed, without needlessly increasing the concentration of a chemical liquid contained in a cleaning liquid CF (the polymers may be removed by a deionized water in some cases). Thus, the front surface Wa of the wafer W can be prevented from being eroded by the chemical liquid contained in the cleaning liquid CF.

Further, since the frictional force smaller than the frictional force to be applied to the rear surface Wb can be applied to the front surface Wa of the wafer W, the front surface Wa of the wafer W can be prevented from being damaged by the first cleaning brush 11.

When the polymers adhere to the rear surface Wb of the wafer W with a stronger adhesiveness, the size of the second cleaning brush 21a may be made larger than the size of the first cleaning brush 11 so as to make larger the area of the second cleaning brush 21a to be in contact with the rear surface Wb of the wafer W than the area of the first cleaning brush 11 to be in contact with the front surface Wa of the wafer W. Alternatively, the second cleaning brush 21a may be rotated at a higher speed than the first cleaning brush 11.

Moreover, both the aforementioned conditions may be adopted. Namely, the size of the second cleaning brush 21a may be made larger than the size of the first cleaning brush 11 so as to make larger the area of the second cleaning brush 21a to be in contact with the rear surface Wb of the wafer W than the area of the first cleaning brush 11 to be in contact with the front surface Wa of the wafer W, and the second cleaning brush 21a may be rotated at a higher speed than the first cleaning brush 11.

### Third Embodiment

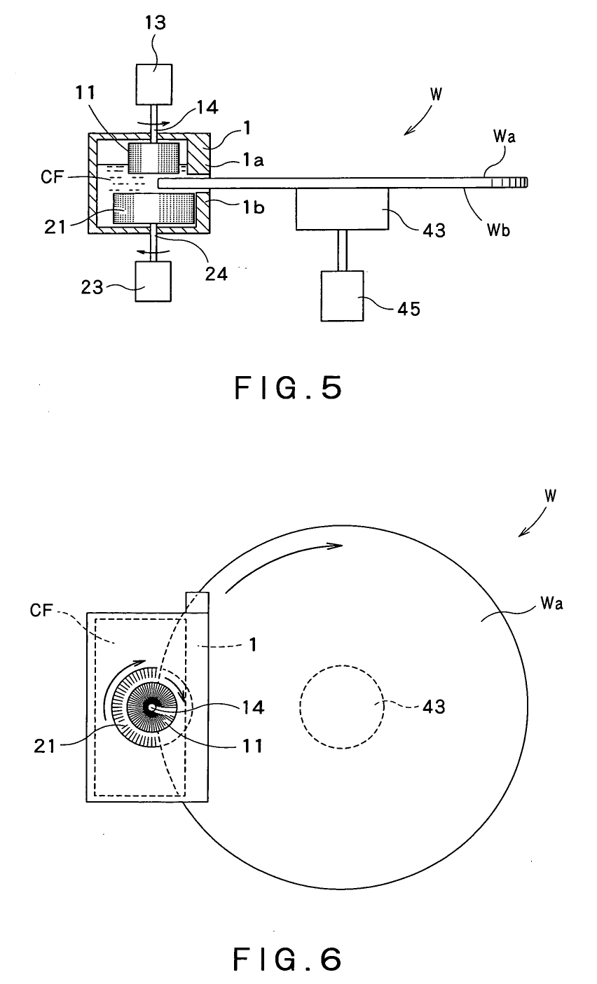

Next, a third embodiment of the present invention will be described with reference to FIG. 5. In the third embodiment shown in FIG. 5, when viewed from a direction shown by the arrow II in FIG. 1 (from a predetermined direction), a second cleaning brush 21 is rotated oppositely to a first cleaning brush 11. The second cleaning brush 21 is rotated at the same speed as the first cleaning brush 11. In this embodiment, in place of the holding members 41, there are disposed an absorbing and holding part 43 that absorbs a substantially central part of a wafer W to hold the same, and a motor 45 that drives the absorbing and holding part 43 in rotation. Other structures are substantially the same as those shown in FIG. 1 and FIGS. 2(a) and 2(b).

In the third embodiment shown in FIG. 5, the components identical to those shown in FIG. 1 and FIGS. 2(a) and 2(b) are represented by the same reference numbers, and a detailed description thereof is omitted.

In this embodiment, when viewed from the direction shown by the arrow II in FIG. 1, the second cleaning brush 21 is rotated counterclockwise, while the first cleaning brush 11 is rotated clockwise. By rotating the first cleaning brush 11 and the second cleaning brush 21 in the opposite directions, the wafer W is subjected to a frictional force by the first cleaning brush 11, the frictional force being opposite to a frictional force applied by the second cleaning brush 21. Thus, the frictional force applied from the second cleaning brush 21 to a rear surface Wb of the wafer W can be further increased, so that polymers adhering to the rear surface Wb of the wafer W can be more reliably removed.

According also to this embodiment, the larger frictional force can be applied to the rear surface Wb to which polymers difficult to be removed from the wafer W are likely to adhere, while the frictional force smaller than the frictional force to be applied to the rear surface Wb can be applied to the front surface Wa to which particles easy to be removed from the wafer W are likely to adhere.

The polymers adhering to the rear surface Wb of the wafer W can be reliably removed, without needlessly increasing the concentration of a chemical liquid contained in the cleaning liquid CF (the polymers may be removed by a deionized water in some cases). Thus, the front surface Wa of the wafer W can be prevented from being eroded by the chemical liquid contained in the cleaning liquid CF.

In addition, since the frictional force to be applied to the front surface Wa of the wafer W can be made smaller, the front surface Wa of the wafer W can be prevented from being damaged by the first cleaning brush 11.

In this embodiment, a size of the second cleaning brush 21 is larger than a size of the first cleaning brush 11, and thus an area of the second cleaning brush 21 to be in contact with the rear surface Wb of the wafer W is larger than an area of the first cleaning brush 11 to be in contact with the front surface Wa of the wafer W. Thus, the frictional force to be applied from the second cleaning brush 21 to the rear surface Wb of the wafer W is larger than the frictional force to be applied from the first cleaning brush 11 to the front surface Wa of the wafer W. Accordingly, the wafer W is rotated by a driving force in the rotational direction of the second cleaning brush 21.

In the above description, the case in which the area of the second cleaning brush 21 to be in contact with the rear surface Wb of the wafer W is made larger than the area of the first cleaning brush 11 to be in contact with the front surface Wa of the wafer W is explained as a method for making larger the frictional force to be applied from the second cleaning brush 21 to the rear surface Wb of the wafer W than the frictional force to be applied from the first cleaning brush 11 to the front surface Wa of the wafer W. However, this embodiment is not limited thereto.

For example, the second cleaning brush 21 may be rotated at a higher speed than the first cleaning brush 11. Alternatively, the second cleaning brush 21 may be made of a material whose coefficient of friction against the wafer W is larger than a coefficient of friction of a material for making the first cleaning brush 11 so as to make larger the frictional force to be applied from the second cleaning brush 21 to the rear surface Wb of the wafer W than the frictional force to be applied from the first cleaning brush 11 to the front surface Wa of the wafer W.

Moreover, in order to more reliably remove the polymers adhering to the rear surface Wb of the wafer W, two of the above-described conditions or all of the above-described conditions may be suitably combined. Namely, the condition in which the area of the second cleaning brush.21 to be in contact with the rear surface Wb of the wafer W is made larger than the area of the first cleaning brush 11 to be in contact with the front surface Wa of the wafer W, the condition in which the second cleaning brush 21 may be rotated at a higher speed than the first cleaning brush 11, and the condition in which the second cleaning brush 21 may be made of a material whose coefficient of friction against the wafer W is larger than a coefficient of friction of a material for making the first cleaning brush 11, may be suitably selected and combined.

In the first and second embodiments, although there has been explained the case in which the two holding member 41 for holding the rear surface Wb of the wafer W are located at a height position which is substantially the same as a height position of the upper surface of the second cleaning brush 21 so that the rear surface Wb of the wafer W is supported by the holding members 41 and the second cleaning brush 21, this embodiment is not limited thereto. For example, similarly to the third embodiment, in place of the holding members 41, there may be disposed an absorbing and holding part 43 that absorbs a substantially central part of the wafer W to hold the same (see, FIG. 6). FIG. 6 shows the structure corresponding to the first embodiment shown in FIG. 1 and FIGS. 2(a) and 2(b). In this case, the motor 45, which is indispensable in the third embodiment, is not required.

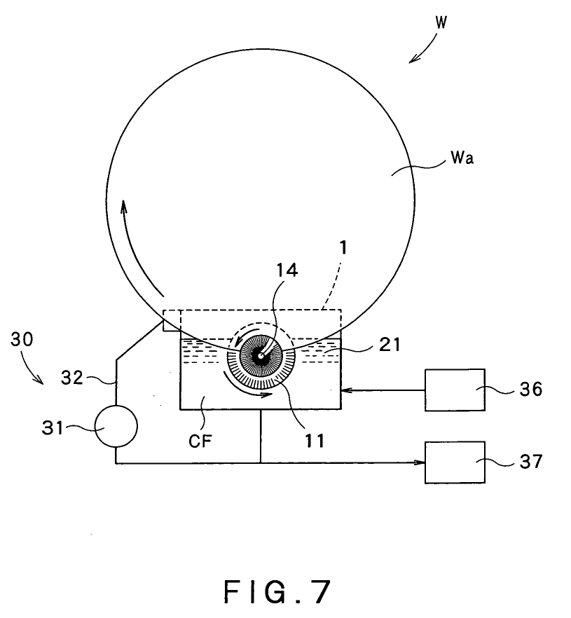

In addition, in the first, second, and third embodiments, although there has been explained the case in which the in-plane direction of the wafer W is oriented to substantially the horizontal direction, this embodiment is not limited thereto. As shown in FIG. 7, the first cleaning brush 11 and the second cleaning brush 21 may support the wafer W such that the in-plane direction of the wafer W is oriented to substantially the vertical direction. FIG. 7 shows the structure corresponding to the first embodiment shown in FIG. 1 and FIGS. 2(a) and 2(b). FIG. 7 is a front view of such a cleaning apparatus.

When the in-plane direction of the wafer W is oriented to substantially the vertical direction, there is a possibility that the cleaning liquid CF, which has cleaned the peripheral part of the wafer W and remains thereon, is moved upward in accordance with the rotation of the wafer W. When the cleaning liquid CF remaining on the wafer W is moved upward, the cleaning liquid CF may then move downward along the front surface Wa and the rear surface Wb of the wafer W, resulting in an adverse effect upon the wafer W.

In order to avoid this, as shown in FIG. 7, preferably connected to an upper part of a containing tank 1 is a suction part 30 that sucks and discharges a cleaning liquid from the upper part of the containing tank 1. As shown in FIG. 7, the suction part 30 includes a suction pipe 32 that is connected to an upper part of the containing tank 1 and is extended to a discharge part 37, and a suction pump 31 disposed in the suction pipe 32 for sucking and discharging the cleaning liquid from the containing tank 1.

By connecting the suction part 30 to the upper part of the containing tank 1, the cleaning liquid can be sucked and discharged from the upper part of the containing tank 1. Thus, the cleaning liquid CF, which has cleaned the peripheral part of the wafer W and remains thereon, can be prevented from being moved upward in accordance with the rotation of the wafer W. Thus, there is no possibility that the cleaning liquid CF remaining on the wafer W is moved upward, and that the cleaning liquid CF then moves downward along the front surface Wa and the rear surface Wb of the wafer W, resulting in an adverse effect upon the wafer W.

When the wafer W is held such that the in-plane direction is oriented to substantially the vertical direction, which is shown in FIG. 7, the holding member 41 for supporting the peripheral part of the wafer W may be selectively provided in consideration of a condition such as a size of the wafer W.

### Fourth Embodiment

Next, a fourth embodiment of a cleaning apparatus and a cleaning method of the present invention will be described with reference to the drawings. FIGS. 8 to 10 are views showing the fourth embodiment of the present invention. In the fourth embodiment shown in FIGS. 8 to 10, the components identical to those shown in FIG. 1 and FIGS. 2(a) and 2(b) are represented by the same reference numbers, and a detailed description thereof is omitted.

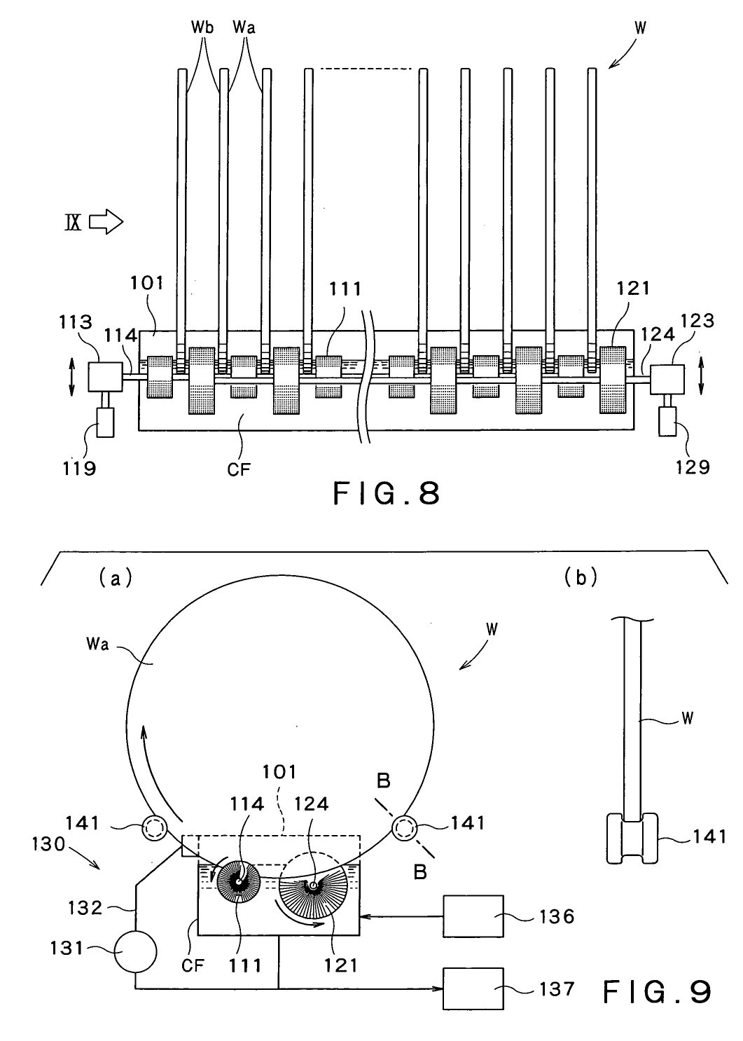

As shown in FIG. 8 and FIG. 9(a), the cleaning apparatus in this embodiment is adapted to clean peripheral parts of a plurality of wafers W as substrates to be processed which are held substantially in the vertical direction. FIG. 8 is a side sectional view of the cleaning apparatus in this embodiment. FIG. 9(a) is a front view of the cleaning apparatus in this embodiment of the present invention when viewed from a direction shown by the arrow IX in FIG. 8. FIG. 9(b) is a longitudinal sectional view of a holding member 141 (described below) taken along the line B-B in FIG. 9(a).

As shown in FIG. 8, the cleaning apparatus includes: a containing tank 101 configured to contain a cleaning liquid CF; a plurality of first cleaning brushes (first cleaning parts) 111 arranged in a row, each first cleaning brush 111 being configured to be brought into contact with a front surface (one surface) Wa of a wafer W and configured to be rotated in an in-plane direction of the wafer W; and a plurality of second cleaning brushes (second cleaning parts) 121 interposed between the first cleaning brushes 111 in the containing tank 101, each second cleaning brush 121 being configured to be brought into contact with a peripheral part of a rear surface (the other surface) Wb of the wafer W and configured to be rotated in the in-plane direction of the wafer W. The front surface Wa of the wafer W is positioned to be opposed to a front surface Wa of an adjacent wafer W on one side, and the rear surface Wb of the wafer W is positioned to be opposed to a rear surface Wb of an adjacent wafer W on the other side.

Each of the first cleaning brushes 111 is interposed between the second cleaning brushes 121, while each of the second cleaning brush 121 is interposed between the first cleaning brushes 111. Namely, the first cleaning brushes 111 and the second cleaning brushes 121 are alternately arranged.

As shown in FIG. 8 and FIG. 9(a), a size of each of the second cleaning brush 121 is larger than a size of each of the first cleaning brushes 111, and thus an area of each of the second cleaning brushes 121 to be in contact with the rear surface Wb of the wafer W is larger than an area of each of the first cleaning brushes 111 to be in contact with the front surface Wa of the wafers W.

As shown in FIG. 8, the first cleaning brushes 111 are connected to a first drive motor 113 via a first rotational shaft 114, while the second cleaning brushes 121 are connected to a second drive motor 124 via a second rotational shaft 124. As shown in FIG. 9(a), the second rotational shaft 124 and the first rotational shaft 114 are displaced from each other in the horizontal direction, such that the first rotational shaft 114 is not in contact with the second cleaning brushes 121 and that the second rotational shaft 124 is not in contact with the first cleaning brushes 111.

As shown in FIG. 9(a), when viewed from a direction shown by the arrow IX in FIG. 8 (from a predetermined direction), the second cleaning brush 121 is rotated in the same direction as the first cleaning brush 111. Specifically, when viewed from the direction shown by the arrow IV in FIG. 8, the second cleaning brush 121 is rotated counterclockwise by the second drive motor 123, and the first cleaning brush 111 is rotated counterclockwise as well by the first drive motor 13 (see, the arrow in FIG. 9(a)).

In FIG. 9(a), a rotational speed of the second drive motor 123 is higher than a rotational speed of the first drive motor 113, so that the second cleaning brush 121 is rotated at a higher speed than the first cleaning brush 111.

As shown in FIG. 9(a), connected to the containing tank 101 are a supply part 136 that supplies the cleaning liquid CF into the containing tank 101, and a discharge part 137 that discharges the cleaning liquid CF contained in the containing tank 101. Connected to the containing tank 101 is a suction part 130 that sucks and discharges the cleaning liquid from the containing tank 1. As shown in FIG. 9(a), the suction part 130 includes a suction pipe 132 that is connected to an upper part of the containing tank 101 and is extended to the discharge part 137, and a suction pump 131 disposed in the suction pipe 132 for sucking and discharging the cleaning liquid from the containing tank 1. In order to reliably suck the cleaning liquid CF adhering to the wafer W, the plurality of suction pipes 132 are preferably located at positions along axial directions of the first rotational shaft 114 and the second rotational shaft 124.

As shown in FIG. 9(a), holding members 141 for supporting the respective wafers W are located at upper opposed parts of the containing tank 101. As shown in FIG. 9(b), the holding member 141 has a recessed portion, whereby the wafer W can be positioned and held in the recessed portion.

Next, an operation of this embodiment as structured above is described.

At first, a plurality of wafers W are placed substantially in the vertical direction such that the respective wafers W are held between the first cleaning brushes 111 and the second cleaning brushes 121. At this time, the front surface Wa of each of the wafers W to which particles are likely to adhere is brought into contact with each of the first cleaning brush 111, and the rear surface Wb of each of the wafers W to which polymers are likely to adhere is brought into contact with each of the second cleaning brushes 121.

Then, the first cleaning brushes 111 are driven in rotation by the first drive motor 113, and the second cleaning brushes 121 are driven in rotation by the second drive motor 123 (see, FIGS. 8 and 9(a)). Specifically, when viewed from the direction shown by the arrow IX in FIG. 8, the second cleaning brush 121 is rotated counterclockwise, and the first cleaning brush 111 is rotated counterclockwise as well (see, the arrow in FIG. 9(a)).

Since the first cleaning brush 111 and the second cleaning brush 121 are driven in rotation, the wafer W is rotated in the in-plane direction by frictional forces applied by the first cleaning brush 111 and the second cleaning brush 121. At this time, when viewed from direction shown by the arrow IX in FIG. 8, the wafer W is rotated clockwise (see, FIG. 9(a)).

As shown in FIGS. 8 and 9(a), the size of the second cleaning brush 121 is larger than the area of the first cleaning brush 111, and thus the area of the second cleaning brush 121 to be in contact with the rear surface Wb of the wafer W is larger than the area of the first cleaning brush 111 to be in contact with the front surface Wa of the wafer W.

Thus, a larger frictional force can be applied to the rear surface Wb to which polymers difficult to be removed from the wafer W are likely to adhere, while a frictional force smaller than the frictional force to be applied to the rear surface Wb can be applied to the front surface Wa to which particles easy to be removed from the wafer W are likely to adhere.

In addition, the rotational speed of the second drive motor 123 is higher than the rotational speed of the first drive motor 113, so that the second cleaning brush 121 is rotated at a higher speed than the first cleaning brush 111. This fact also makes it possible that a larger frictional force can be applied to the rear surface Wb to which polymers difficult to be removed from the wafers W are likely to adhere, and that a frictional force smaller than the frictional force to be applied to the rear surface Wb can be applied to the front surface Wa to which particles easy to be removed from the wafers W are likely to adhere.

According to this embodiment, the frictional force to be applied from the second cleaning brush 121 to the rear surface Wb of the wafer W can be made larger than the frictional force to be applied from the first cleaning brush 111 to the front surface Wa of the substrate to be processed. Thus, even in a case in which different objects are intended to be removed from the front surface Wa and the rear surface Wb of the wafer W, the respective objects can be reliably removed. More specifically, causes of particles, such as dusts, adhering to the front surface Wa of the wafer W and polymers adhering to the rear surface Wb of the wafer W can be reliably removed. In addition, the polymers adhering to the rear surface Wb of the wafer W can be reliably removed, without needlessly increasing the concentration of a chemical liquid contained in the cleaning liquid CF (the polymers may be removed by a deionized water in some cases). Thus, the front surface Wa of the wafer W can be prevented from being eroded by the chemical liquid contained in the cleaning liquid CF.

Further, since the frictional force smaller than the frictional force to be applied to the rear surface Wb can be applied to the front surface Wa of the wafer W, the front surface Wa of the wafer W can be prevented from being damaged by the first cleaning brush 111.

Namely, according to the conventional technique, when a wafer is cleaned by a cleaning liquid containing a chemical liquid of a lower concentration, polymers adhering to a rear surface of the wafer cannot be sufficiently removed. Meanwhile, when a cleaning liquid containing a potent chemical liquid is used so as to remove polymers adhering to the rear surface, a front surface of the wafer W may be undesirably eroded.

On the other hand, according to this embodiment, since the frictional force to be applied from the second cleaning brush 121 to the rear surface Wb of the wafer W is made larger, even when a cleaning liquid containing a chemical liquid of a lower concentration (a deionized water may be used in some cases), polymers adhering to the rear surface Wb of the wafer W can be reliably removed. Since such a cleaning liquid containing a chemical liquid of a lower concentration can be used, the front surface Wa of the wafer W can be prevented from being eroded.

Further, since the frictional force smaller than the frictional force to be applied to the rear surface Wb can be applied to the front surface Wa of the wafer W, the front surface Wa of the wafer W can be prevented from being damaged by the first cleaning brush 111.

As described above, during when the wafer W is rotated in the in-plane direction by the frictional forces from the first cleaning brush 111 and the second cleaning brush 121, the cleaning liquid is sucked and discharged from the upper part of the containing tank 101 by the suction part 130 connected to the upper part of the containing tank 101 (see, FIG. 9(a)).

Unless the cleaning liquid is sucked and discharged from the upper part of the cleaning tank 101, there is a possibility that the cleaning liquid CF, which has cleaned the peripheral part of the wafer W and remains thereon, is moved upward in accordance with the rotation of the wafer W. When the cleaning liquid CF remaining on the wafer W is moved upward, the cleaning liquid CF may then move downward to a part which should not to be cleaned by the cleaning liquid CF along the front surface Wa and the rear surface Wb of the wafers W, resulting in an adverse effect upon the wafer W.

On the other hand, according to this embodiment, since the cleaning liquid is sucked and discharged from the upper part of the containing tank 101, the cleaning liquid CF which has cleaned the peripheral part of the wafer W and remains thereon can be prevented from being moved upward in accordance with the rotation of the wafer W. Thus, an adverse effect upon the wafer W can be prevented, which might be caused by the cleaning liquid CF moving downward along the front surface Wa and the rear surface Wb of the wafer W.

In the above description, there has been explained the case in which the area of the second cleaning brush 121 to be in contact with the rear surface Wb of the wafer W is larger than the area of the first cleaning brush 111 to be in contact with the front surface Wa of the wafer W, the second cleaning brush 121 is rotated at a higher speed than the first cleaning brush 111. However, when an adhesiveness of the polymers to the rear surface Wb of the wafer W is not so strong, adoption of only one of the above conditions may be sufficient.

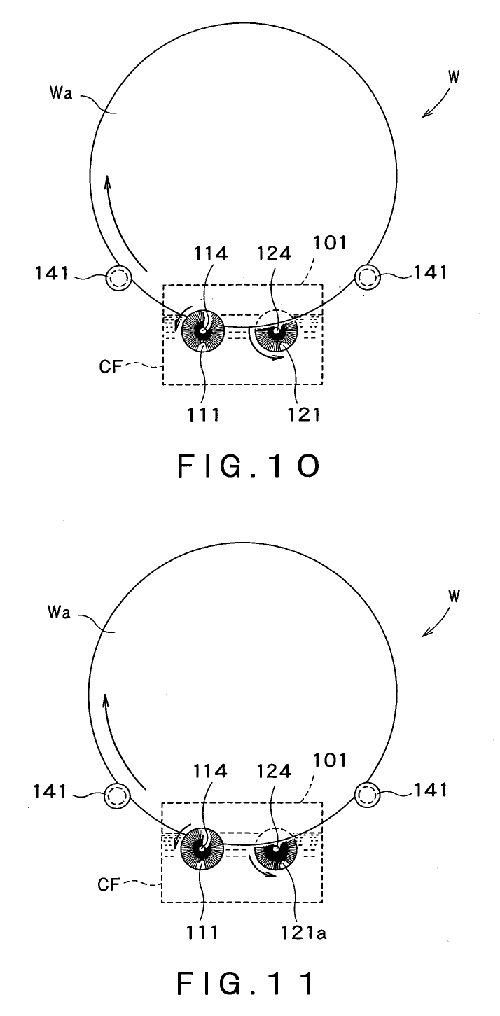

That is, in FIG. 9(a), the second cleaning brush 121 may be rotated at the same speed as the first cleaning brush 111. Alternatively, as shown in FIG. 10, the size of the second cleaning brush 121 may be the same as the size of the first cleaning brush 111 to make substantially equal the area of the second cleaning brush 121 to be in contact with the rear surface Wb of the wafer W and the area of the first cleaning brush 111 to be in contact with the front surfaces Wa of the wafer W to each other, and the second cleaning brush 121 may be rotated at a higher speed than the first cleaning brush 111.

In FIG. 8, the first cleaning brush 111, the first rotational shaft 114, and the first drive motor 113 may be moved upward and downward by an upward and downward driving mechanism such as a motor 119 or a cylinder (the motor 119 is used in FIG. 8), and the second cleaning brush 121, the second rotational shaft 124, and the second drive motor 123 may be moved upward and downward by an upward and downward driving mechanism such as a motor 129 or a cylinder (the motor 129 is used in FIG. 8) (see, the arrows indicating the upward and downward directions).

Since the first cleaning brush 111, the first rotational shaft 114, and the first drive motor 113 can be moved upward and downward, and the second cleaning brush 121, the second rotational shaft 124, and the second drive motor 123 can be moved upward and downward, the area (removed width) of the first cleaning brush 111 to be in contact with the front surface Wa of the wafer W and the area (removed width) of the second cleaning brush 121 to be in contact with the rear surface Wb of the wafer W can be suitably adjusted.

In a case in which the first cleaning brush 111, the first rotational shaft 114, and the first drive motor 113 can be moved upward and downward, and the second cleaning brush 121, the second rotational shaft 124, and the second drive motor 123 can be moved upward and downward, even when the size of the second cleaning brush 121 and the first cleaning brush 111 are identical to each other, by moving upward the second cleaning brush 121 to a position above the first cleaning brush 111, the area (removed width) to be in contact with the rear surface Wb of the wafer W can be made larger than the area (removed width) to be in contact with the front surface Wa of the wafer W, whereby the frictional force to be applied to the rear surface Wb of the wafer W can be made larger than the frictional force to be applied to the front surface Wa of the wafers W.

### Fifth Embodiment

Next, a fifth embodiment of the present invention will be described with reference to FIG. 11. In the fifth embodiment shown in FIG. 11, each of first cleaning brushes 111 and each of second cleaning brushes 121a are made of different materials, and a coefficient of friction of the material for making the second cleaning brush 121a against a wafer W is larger than a coefficient of friction of the material for making the first cleaning brush 111 against the wafer W. Further, a size of the second cleaning brush 121a is about the same as a size of the first cleaning brush 111, and thus an area of the second cleaning brush 121a to be in contact with a rear surface Wb of the wafer W is substantially equal to an area of the first cleaning brush 111 to be in contact with a front surface Wa of the wafer W. Furthermore, the second cleaning brush 121a is rotated at the same speed as the first cleaning brush 111. Other structures are substantially the same as those of the fourth embodiment shown in FIG. 8 and FIGS. 9(a) and 9(b).

In the fifth embodiment shown in FIG. 11, the components identical to those shown in FIG. 8 and FIG. 9(a) and 9(b) are represented by the same reference numbers, and a detailed description thereof is omitted.

In FIG. 11, the first cleaning brush 111 and the second cleaning brush 121a are made of different materials, and the coefficient of friction of the material for making the second cleaning brush 121a against the wafer W is larger than the coefficient of friction of the material for making the first cleaning brush 111 against the wafer W.

Thus, similarly to the fourth embodiment, a larger frictional force can be applied to the rear surface Wb to which polymers difficult to be removed from the wafer W are likely to adhere, while a frictional force smaller than the frictional force to be applied to the rear surface Wb can be applied to the front surface Wa to which particles easy to be removed from the wafer W are likely to adhere.

As a result, the polymers adhering to the rear surface Wb of the wafer W can be reliably removed, without needlessly increasing the concentration of a chemical liquid contained in a cleaning liquid CF (the polymers may be removed by a deionized water in some cases). Thus, the front surface Wa of the wafer W can be prevented from being eroded by the chemical liquid contained in the cleaning liquid CF.

Further, since the frictional force smaller than the frictional force to be applied to the rear surface Wb can be applied to the front surface Wa of the wafer W, the front surface Wa of the wafer W can be prevented from being damaged by the first cleaning brush 111.

When the polymers adhere to the rear surface Wb of the wafer W with a stronger adhesiveness, the size of the second cleaning brush 121a may be made larger than the size of the first cleaning brush 111 so as to make larger the area of the second cleaning brush 121a to be in contact with the rear surface Wb of the wafer W than the area of the first cleaning brush 111 to be in contact with the front surface Wa of the wafer W. Alternatively, the second cleaning brush 121a may be rotated at a higher speed than the first cleaning brush 111.

Moreover, both the aforementioned conditions may be adopted. Namely, the size of the second cleaning brush 121a may be made larger than the size of the first cleaning brush 111 so as to make larger the area of the second cleaning brush 121a to be in contact with the rear surface Wb of the wafer W than the area of the first cleaning brush 111 to be in contact with the front surface Wa of the wafer W, and the second cleaning brush 121a may be rotated at a higher speed than the first cleaning brush 111.

### Sixth Embodiment

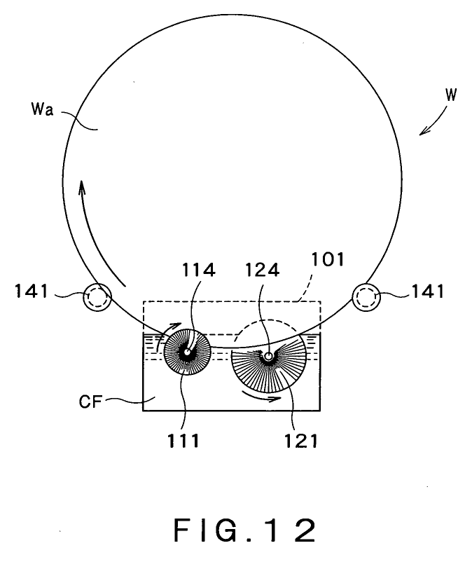

Next, a sixth embodiment of the present invention will be described with reference to FIG. 12. In the sixth embodiment shown in FIG. 12, when viewed from a direction shown by the arrow IX in FIG. 8 (from a predetermined direction), each of second cleaning brushes 121 is rotated oppositely to each of first cleaning brushes 111. The second cleaning brush 121 is rotated at the same speed as the first cleaning brush 111. Other structures are substantially the same as those shown in FIG. 8 and FIGS. 9(a) and 9(b).

In the sixth embodiment shown in FIG. 12, the components identical to those shown in FIG. 8 and FIGS. 9(a) and 9(b) are represented by the same reference numbers, and a detailed description thereof is omitted.

In this embodiment, when viewed from the direction shown by the arrow IX in FIG. 8 (from the predetermined direction), the second cleaning brush 121 is rotated counterclockwise, while the first cleaning brush 111 is rotated clockwise. By rotating the first cleaning brush 111 and the second cleaning brush 121 in the opposite directions, the wafer W is subjected to a frictional force by the first cleaning brush 111, the frictional force being opposite to a frictional force applied by the second cleaning brush 121. Thus, the frictional force applied from the second cleaning brush 121 to a rear surface Wb of the wafer W can be further increased, so that polymers adhering to the rear surface Wb of the wafer W can be more reliably removed.

According also to this embodiment, the larger frictional force can be applied to the rear surface Wb to which polymers difficult to be removed from the wafer W are likely to adhere, while the frictional force smaller than the frictional force to be applied to the rear surface Wb can be applied to the front surface Wa to which particles easy to be removed from the wafer W are likely to adhere.

The polymers adhering to the rear surface Wb of the wafer W can be reliably removed, without needlessly increasing the concentration of a chemical liquid contained in the cleaning liquid CF (the polymers may be removed by a deionized water in some cases). Thus, the front surface Wa of the wafer W can be prevented from being eroded by the chemical liquid contained in the cleaning liquid CF.

In addition, since the frictional force to be applied to the front surface Wa of the wafer W can be made smaller, the front surface Wa of the wafer W can be prevented from being damaged by the first cleaning brush 11.

In this embodiment, a size of the second cleaning brush 121 is larger than a size of the first cleaning brush 111, and thus an area of the second cleaning brush 121 to be in contact with the rear surface Wb of the wafer W is larger than an area of the first cleaning brush 111 to be in contact with the front surface Wa of the wafer W. Thus, the frictional force to be applied from the second cleaning brush 121 to the rear surface Wb of the wafer W is larger than the frictional force to be applied from the first cleaning brush 111 to the front surface Wa of the wafer W. Accordingly, the wafer W is rotated by a driving force in the rotational direction of the second cleaning brush 121. To be specific, as shown in FIG. 12, the wafer W is rotated clockwise.

In the above description, the case in which the area of the second cleaning brush 121 to be in contact with the rear surface Wb of the wafer W is made larger than the area of the first cleaning brush 111 to be in contact with the front surface Wa of the wafer W is explained as a method for making larger the frictional force to be applied from the second cleaning brush 121 to the rear surface Wb of the wafer W than the frictional force to be applied from the first cleaning brush 11 to the front surface Wa of the wafer W. However, this embodiment is not limited thereto.

For example, the second cleaning brush 121 may be rotated at a higher speed than the first cleaning brush 111. Alternatively, the second cleaning brush 121 may be made of a material whose coefficient of friction against the wafer W is larger than a coefficient of friction of a material for making the first cleaning brush 111 so as to make larger the frictional force to be applied from the second cleaning brush 121 to the rear surface Wb of the wafer W than the frictional force to be applied from the first cleaning brush 111 to the front surface Wa of the wafer W.

Moreover, in order to more reliably remove the polymers adhering to the rear surface Wb of the wafer W, two of the following conditions or all of the following conditions may be suitably combined. Namely, the condition in which the area of the second cleaning brush 121 to be in contact with the rear surface Wb of the wafer W is made larger than the area of the first cleaning brush 111 to be in contact with the front surface Wa of the wafer W, the condition in which the second cleaning brush 21 may be rotated at a higher speed than the first cleaning brush 111, and the condition in which the second cleaning brush 121 may be made of a material whose coefficient of friction against the wafer W is larger than a coefficient of friction of a material for making the first cleaning brush 111, may be suitably combined.

1. A cleaning apparatus for cleaning a peripheral part of a substrate to be processed, comprising:
a first cleaning part configured to be brought into contact with a peripheral part of one surface of the substrate to be processed, and configured to be driven in rotation in an in-plane direction of the substrate to be processed; and
a second cleaning part configured to be brought into contact with a peripheral part of the other surface of the substrate to be processed, and configured to be driven in rotation in the in-plane direction of the substrate to be processed;
wherein a frictional force to be applied from the second cleaning part to the other surface of the substrate to be processed is larger than a frictional force to be applied from the first cleaning part to the one surface of the substrate to be processed.

2. The cleaning apparatus according to claim 1, wherein
the second cleaning part is rotated at a higher speed than the first cleaning part.

3. The cleaning apparatus according to claim 1, wherein
an area of the second cleaning part to be in contact with the other surface of the substrate to be processed is larger than an area of the first cleaning part to be in contact with the one surface of the substrate to be processed.

4. The cleaning apparatus according to claim 1, wherein
the first cleaning part and the second cleaning part are made of different materials, and
a coefficient of friction of the material for making the second cleaning part against the substrate to be processed is larger than a coefficient of friction of the material for making the first cleaning part against the substrate to be processed.

5. The cleaning apparatus according to claim 1, wherein
when viewed from a predetermined direction, the second cleaning part is rotated oppositely to the first cleaning part.

6. The cleaning apparatus according to claim. 1, further comprising:
a containing tank configured to contain a cleaning liquid;
a supply part connected to the containing tank, the supply part being configured to supply a cleaning liquid into the containing tank;
a discharge part connected to the containing tank, the discharge part being configured to discharge a cleaning liquid contained in the containing tank; and
a suction part connected to an upper part of the containing tank, the suction part being configured to suck and discharge the cleaning liquid from the upper part of the containing tank;
wherein the first cleaning part and the second cleaning part support the substrate to be processed such that an in-plane direction of the substrate to be processed is oriented to substantially the vertical direction.

7. A cleaning method for cleaning a peripheral part of a substrate to be processed, the cleaning method being performed by a cleaning apparatus including a first cleaning part configured to be driven in rotation in an in-plane direction of the substrate to be processed, and a second cleaning part configured to be driven in rotation in the in-plane direction of the substrate to be processed, the cleaning method comprising:
a step in which a substrate to be processed is interposed between the first cleaning part and the second cleaning part such that the first cleaning part is brought into contact with a peripheral part of one surface of the substrate to be processed and that the second cleaning part is brought into contact with a peripheral part of the other surface of the substrate to be processed; and
a step in which a frictional force is applied by the second cleaning part to the other surface of the substrate to be processed, the frictional force being larger than a frictional force to be applied by the first cleaning part to the one surface of the substrate to be processed.

8. A cleaning apparatus for cleaning peripheral parts of a plurality of substrates to be processed that are held substantially in the vertical direction, the cleaning apparatus comprising:
a containing tank configured to contain a cleaning liquid;
a first cleaning part disposed in the cleaning tank, the first cleaning part being configured to be brought into contact with a peripheral part of one surface of the substrate to be processed, and configured to be driven in rotation in an in-plane direction of the substrate to be processed; and
a second cleaning part disposed in the cleaning tank, the second cleaning part being configured to be brought into contact with a peripheral part of the other surface of the substrate to be processed, and configured to be driven in rotation in the in-plane direction of the substrate to be processed;
wherein at least one of the first cleaning part and the second cleaning part comprises a plurality of cleaning parts, and
a frictional force to be applied from the second cleaning part to the other surface of the substrate to be processed is larger than a frictional force to be applied from the first cleaning part to the one surface of the substrate to be processed.

9. The cleaning apparatus according to claim 8, wherein
the first cleaning part and the second cleaning part are alternately arranged.

10. The cleaning apparatus according to claim 8, wherein
the second cleaning part is rotated at a higher speed than the first cleaning part.

11. The cleaning apparatus according to claim 8, wherein
an area of the second cleaning part to be in contact with the other surface of the substrate to be processed is larger than an area of the first cleaning part to be in contact with the one surface of the substrate to be processed.

12. The cleaning apparatus according to claim 8, wherein
the first cleaning part and the second cleaning part are made of different materials, and
a coefficient of friction of the material for making the second cleaning part against the substrate to be processed is larger than a coefficient of friction of the material for making the first cleaning part against the substrate to be processed.

13. The cleaning apparatus according to claim 8, wherein
when viewed from a predetermined direction, the second cleaning part is rotated oppositely to the first cleaning part.

14. The cleaning apparatus according to claim 8, further comprising:
a supply part connected to the containing tank, the supply part being configured to supply a cleaning liquid into the containing tank;
a discharge part connected to the containing tank, the discharge part being configured to discharge a cleaning liquid contained in the containing tank; and
a suction part connected to an upper part of the containing tank, the suction part being configured to suck and discharge the cleaning liquid from the upper part of the containing tank.

15. A cleaning method for cleaning peripheral parts of a plurality of substrates to be processed that are held substantially in the vertical direction, the cleaning method being performed by a cleaning apparatus including: a containing tank configured to contain a cleaning liquid; a first cleaning part disposed in the containing tank, the first cleaning part being configured to be driven in rotation in an in-plane direction of the substrate to be processed; and a second cleaning part disposed in the containing tank, the second cleaning part being configured to be driven in rotation in the in-plane direction of the substrate to be processed; wherein at least one of the first cleaning part and the second cleaning part comprises a plurality of cleaning parts; the cleaning method comprising:
a step in which a substrate to be processed is interposed between the first cleaning part and the second cleaning part substantially in the vertical direction such that the first cleaning part is brought into contact with a peripheral part of one surface of the substrate to be processed and that the second cleaning part is brought into contact with a peripheral part of the other surface of the substrate to be processed; and
a step in which a frictional force is applied by the second cleaning part to the other surface of the substrate to be processed, the frictional force being larger than a frictional force to be applied by the first cleaning part to the one surface of the substrate to be processed.
